(19) United States
(12) Patent Application Publication
(10) Pub. No.: US 2011/0029298 A1
(43) Pub. Date: Feb. 3, 2011

(54) Method of modelling noise injected into an electronic system

(76) Inventors: Francois Clement, Virieu Sur Bourbre (FR); Amine Dhia, Grenoble (FR); Benoit Emmanuel Fabin, Grenoble (FR)

Correspondence Address: IM IP Law PLLC, P.O. Box 333, Hartsdale, NY, 10530, US

(21) Appl. No.: 12/308,782

(22) PCT Filed: Jun. 26, 2007
(86) PCT No.: PCT/FR2007/051536

§ 371 Date: Sep. 2, 2010

(30) Foreign Application Priority Data
Jun. 26, 2006 (FR) 06 52642

(51) Int. Cl. G06F 17/50

(52) U.S. Cl. 703/13

(57) ABSTRACT

Method for modelling the noise injected into an electronic system. The invention relates to a method of modelling the noise injected into a mixed system (1) of digital and analogue, and/or radio-frequency type. In the invention, the injection of noise in the system (1) is modelled by macro-models of digital cells (8, 8.1-8.N) which model, in particular, noise related to the switching of the digital cells (C1-CN), and by models of lines (L1-LN) modelling, in particular, the noise resulting from a change of state of the signals transported over the lines.

The present invention relates to a method for modeling noise injected into an electronic system. The object of the invention is, among other things, to increase the precision of such modeling. The invention is particularly advantageously applicable to the field of mixed electronic systems comprising analog and digital components. To give a nonlimiting example, electronic systems include integrated circuits on a single silicon chip or on several silicon substrates in the same package, as well as the assembly of components (whether integrated or not) on a printed circuit.

The manufacture of these electronic systems is a very costly operation, particularly when the system comprises one or more integrated components on silicon. Thus, before starting mass production, it is essential to test all of the manufacturing parameters, and to assign them certain values in order to maximize the probability that the manufactured circuit will function properly.

To this end, there is a set of software products called “electronic design automation tools,” which make it possible to aid in the design of electronic systems, from the description of the specifications of the system to be produced to the production of the photographic masks used during the manufacture of the system.

One important factor in the design of an electronic system is quantifying the noise produced by the circuits, particularly in a mixed system. In essence, prior to manufacture, there is a step that consists of verifying the integrity of the signals in SIP (System In Package) or SOC (System on Chip) systems, i.e. of obtaining a precise mapping of the observable noise in the system via simulation, in order to find out whether or not certain noise-sensitive circuits will function.

To this end, noise-generating circuits (aggressors) and noise-sensitive circuits (victims) are identified. More precisely, all of the circuits of the system can be considered to be noise generators (aggressors). However, it is preferable to choose the noise-generating circuits from the group that includes digital circuits, memory cells, analog/RF circuits such as VCOs (Voltage Controlled Oscillators), power amplifiers and input/output circuits. In particular, digital circuits have a tendency to generate noise at the moment when their input signals are switched. It is understood that a circuit comprising at least one noise-generating circuit is itself considered to be a noise-generating circuit.

The noise-sensitive circuits (victims) are chosen from the group that includes analog/RF circuits such as amplifiers, filters, oscillators, mixers, sample-and-hold circuits, digital memory circuits, phase loops, input/output circuits and voltage references. It is understood that a circuit comprising at least one noise-sensitive circuit is itself considered to be noise-sensitive.

The noise generated by the aggressors is transmitted to the victims by passing through the substrates on which the circuits, the metal interconnects and the packages are mounted. This noise has a tendency to degrade the performance of the victims. Thus, noise is understood to mean any signal generated by an aggressor block that has an undesirable influence on the victims.

More precisely, a mixed system comprises both digital and analog cells. A cell is an elementary system of the circuit which may be analog or digital. A cell fulfills a given function, and can for example take the form of a logic gate or a set of logic gates.

The observable noise in such systems is mainly linked to the switching activity of the digital cells. This switching activity causes the consumption of a current flowing through supply rails connected to the cells or originating from capacitive loads of cells or elements of adjacent circuits. This consumption produces voltage fluctuations in the system's power grid, known as IR drop. Moreover, the switching of the cells results in localized leakage currents in the channel of the MOS transistors composing the cells. These leakage currents flow toward the substrate and create voltage fluctuations in an impedance network, for example of the RLC type, modeling the substrate.

In U.S. Pat. No. 6,941,258, each cell of an integrated circuit is associated with a noise macromodel which describes the aforementioned noise injection modes at the level of the digital cells. To this end, each macromodel includes active elements, such as current sources, which inject noise into the rest of the system. These sources, which model the noise injected into the circuit, are linked to the switching activity of the cells. In addition, the macromodel includes passive elements, such as resistors and capacitors, which model the connections between the terminals of the cell, the supply nodes and the connection to the substrate.

To extract the current sources from the macromodel, the noise current injected by the cell is calculated using a simulation model on the transistor level of the cell developed with the aid of a Spice-type software program, for example. This model is very detailed and reproduces most of the variations and physical phenomena of this cell. This model is placed in a test environment dedicated to extraction. The active elements of the cell noise injection model are deduced from the simulations of the Spice model of the cell in the test environment, and the passive elements are extracted from the layout of the circuit.

However, the injection macromodel proposed in the document U.S. Pat. No. 6,941,258 has limits, since it does not model all of the noise injection phenomena that are capable of modifying the equilibrium of an electronic system. In fact, the cells are connected to one another by metal interconnects (or lines) of particular size. Yet the known method does not take into account the disturbances of the signals transmitted by the cells, which propagate through these interconnections of the system. Moreover, the known method does not take into account the coupling between these lines or the coupling between these lines and the rest of the electronic system.

Thus, the object of the invention is to generate a noise injection model that takes into account the switching activity of the cells and the disturbances at the level of the lines that connect these cells to each other.

To this end, in the invention, a combination of macromodels is used to model the essential noise injection phenomena created by an active digital circuit that is part of a mixed system. To this end, the macromodel of noise injection at the cell level is supplemented by a macromodel of noise injection at the line level. This macromodel models the noise transported by the lines of the system.

More precisely, the macromodel that models noise injection at the cell level includes passive elements and active elements. In one embodiment, the passive elements are extracted from the layout of each cell. Moreover, the active elements are characterized noise sources which are extracted using known techniques involving all-transistor cell models whose switching and leakage currents are recorded while these models are used in a test environment representing the usage environment of the cell.

The macromodel that models noise injection at the line level comprises a model of a line between the cells, called a passive line micromodel, which includes passive elements such as resistors, capacitors and inductors. When there are two lines adjacent to each other, mutual inductors are included in the inductor model. In order to model the behavior of the inputs of the cells connected to the line for which the noise injection is being modeled, the input capacitances of these cells are extracted. These input capacitances are connected to the passive elements of the passive line macromodel.

The line noise macromodel also includes active elements such as voltage sources representing the variations in the signals flowing through the lines. The spectrum of a PWL (Piecewise Linear) waveform is preferably used to model the activity of the signal in terms of switching. This waveform is defined by its period, its duty cycle, and its rising and falling times. In order to calculate the noise injection at the line level, the observable switching activity in the lines of the system is modeled, and noise injection spectra are assigned to each line.

In order to determine the noise in the system as a whole, the cell noise injection macromodels are joined to the line noise macro modules, to the model of the substrate, and to the model of the power network. The noise levels present in the various nodes of the system are then measured, a node being an equipotential point in the system.

It is also possible to establish criteria for selecting the lines of the system be to macromodeled, so as to model the lines in which the noise and/or the effect on the victims will theoretically be preponderant. Thus, a signal-type criterion makes it possible to consider only the lines in which a particular signal, such as the clock signal, is observable. A line length criterion makes it possible to take into account only the lines whose length is longer than a minimum length.

It is also possible to establish a switching activity probability criterion. In that case, the system can be analyzed probabilistically by assigning each cell a switching probability and considering only the lines connected to cells whose switching probability is greater than a minimum value. It is also possible to incorporate ranges, i.e. to consider the maximum number of lines that can switch during one clock period of the system.

A proximity criterion makes it possible to consider only the lines that have substantial coupling with other lines, or to consider only the lines near power networks or victims.

The invention thus makes it possible to precisely model the noise injection phenomena in the mixed electronic system, while allowing the user to take into account only the most useful line macromodels, i.e. those that make the largest contributions to the noise present in the mixed system as a whole. The selection of the useful line models is based on their influence on the performance of the system, but also on the quality of the noise estimator, and on the worst and best cases of noise injection in the system, etc.

The invention thus allows total control of the noise injection phenomena in the mixed system.

Thus, the invention relates to a method for modeling noise injected into a mixed digital and analog and/or RF system for the design of such systems, this system comprising analog and digital cells, each of these cells performing a particular function, these cells being connected to each other by lines, each line connecting an output of a source cell to an input of a target cell and transporting a signal from the source cell to the target cell, this method comprising the following step:
modeling the injection of noise into the system at the level of the digital cells using cell macromodels, these cell macromodels comprising passive elements and active elements for modeling a switching noise injected into the system, this switching noise being linked to the switching of the digital cells,

characterized in that it also comprises the following step:
modeling the injection of noise into the system at the level of the lines of the system using line macromodels, these line macromodels modeling, in particular, the noise resulting from the change in the state of the signals transported through the lines.

The invention will be more clearly understood by reading the following description and examining the accompanying figures. These figures are provided merely to illustrate and not to limit the invention. These figures show:

FIG. 1: a schematic illustration of an integrated circuit used to implement the method according to the invention;

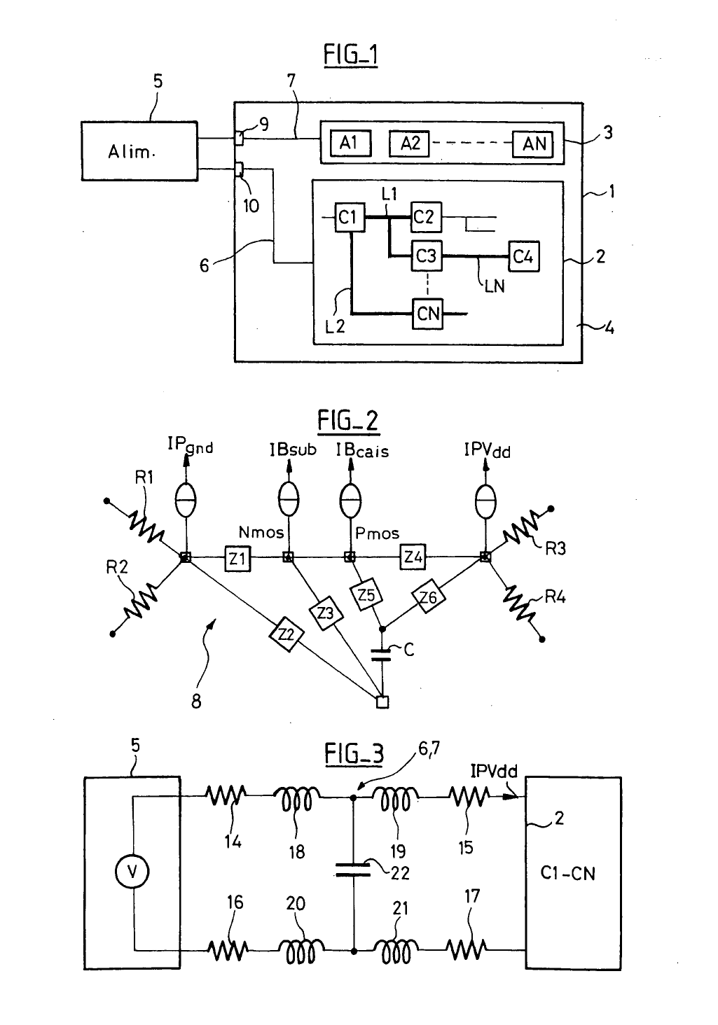

FIG. 2: a schematic illustration of a macromodel of noise injection at the cell level according to the invention;

FIG. 3: an illustration of a macromodel of noise injection at the level of a power network of the cells;

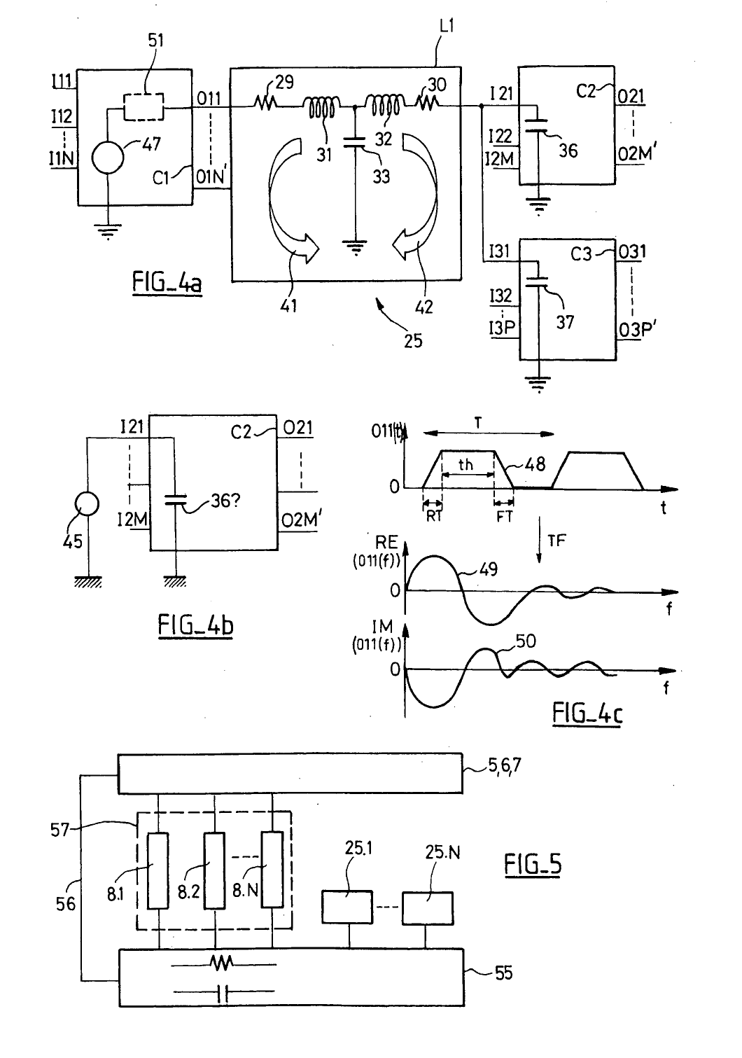

FIG. 4a: a schematic illustration of a line macromodel according to the invention which models noise injection at the level of a line of the system connecting an output of one cell to inputs of several cells;

FIG. 4b: an illustration of a test environment for the cell according to the invention for extracting the input capacitance of a cell whose input is connected to the line for which the noise injection is being modeled;

FIG. 4c: a schematic illustration of a signal from the voltage source modeling an output signal from the cell whose output is connected to the line at the level of which the noise injection is being modeled;

FIG. 5: an illustration of an assembly according to the invention of various noise injection models and passive models for generating a complete model of the mixed system.

Identical elements retain the same references from one figure to the next.

FIG. 1 shows an integrated circuit 1 comprising a digital block 2 and an analog block 3 mounted on a substrate 4 of this circuit 1. The digital block 2 and the analog block 3 respectively comprise digital cells C1-CN and analog cells A1-AN, which perform elementary functions. In a variant, the circuit 1 includes RF cells or any other mixed-system variant.

The digital cells C1-CN inject noise into the circuit 1 as they switch. This noise is capable of modifying the operation of the analog cells A1-AN. There is a hierarchy of the digital blocks, a first hierarchical level being a single transistor, a second hierarchical level being a cell performing an elementary function such as an OR or AND function, a third level being an assembly of elementary functions for performing a given function, the number of hierarchical levels not being limited. It is thus possible to model injected noise for various hierarchical levels of a block.

Furthermore, the cells C1-CN are connected to each other via lines L1-LN, which transmit signals from one cell to another. Thus, the line L1 connects an output of the cell C1 to an input of the cell C2, and to an input of the cell C3. And the line L2 connects an output of the cell C1 to an input of the cell CN. The lines L1, L2 are made of metal, the cells being connected by levels of metallization in the circuit 1 or by wire leads or tracks in integrated circuits. A noise is injected through these lines L1, L2 into the circuit 1 during the switching of the digital cells. This line noise contributes to all of the other mechanisms that inject noise into the circuit 1.

A power network comprises a power supply 5 outside the integrated circuit 1, which is connected to this integrated circuit by power connectors 9, 10. This power supply 5 is also connected to the digital block 2 by an interconnection 6 and to the analog block 3 by an interconnection 7. The power network formed by 5, 6, 7, 9 and 10 supplies power to the various cells of the circuit 1 and is subject to voltage variations during the change in the state of the inputs of the digital cells C1-CN.

In the invention, it is possible to model the generation of noise by the cells as they switch and the propagation of this noise in the power network, the substrate and the lines of the circuit

The injection of noise into the substrate 4 and the power network by a digital cell C1-CN can be modeled by a macromodel 8 illustrated in FIG. 2. This macromodel 8 includes four current sources IPvdd, IPgnd, IBsub and IBcais, which model the noise generated by the switching of the NMOS and PMOS transistors of the cell. This noise is injected into the substrate 4 and into the power network which powers the cells that are switching.

More precisely, the current IPvdd is the current consumed by the cell in order to switch. The current IPgnd, which goes to the ground, is different from the supply current IPvdd, since part of the supply current IPvdd is diverted to output loads and to the substrate 4 of the circuit. The current IBsub is a leakage current to the substrate, while the current IBcais is a leakage current to the well of the circuit 1.

Furthermore, the connections between the terminals of the cell and the substrate 4 are modeled by impedances Z1-Z6 connected to each other. In addition, a capacitor C connecting two resistor networks Z1-Z3 and Z4-Z6 models the connection between the N-doped part of the substrate and the P-doped part. The macromodel 8 is connected to the rest of the integrated circuit 1 via resistors R1-R4. The values of the elements Z1-Z6, C and R1-R4 are theoretically extracted from a layout of the circuit 1, i.e. from a positioning of the components on the circuit 1 and their interconnections.

In a variant, the macromodels can also include several power supplies and the parasitic elements of the structures of the transistors can be modeled in different ways.

The current sources of the macromodel 8 are extracted for each cell using a transistor-level model of each cell. This model precisely models each physical phenomenon occurring in the cell. By placing the cell thus modeled in a particular test environment and varying certain parameters of that environment, such as the input signal values and the output capacitance values of the cells, it is possible to extract the current sources of the cell and to model various noise injection modes of the transistors that compose this cell.

Furthermore, a digital cell being connected to the substrate 4 and to the power network, the noise injection is modeled at the level of the interconnections 6, 7 between the cells C1-CN and the power supply, as illustrated in FIG. 3. To this end, the power network is modeled by resistors 14-17, inductors 18-21 and a capacitor 22 connected to each other, to the power supply 5, and to the cells C1-CN.

This modeling of the power network takes into account the observable voltage fluctuation phenomena in the interconnections of the power supply when the cells C1-CN switch. In essence, when a cell consumes a current IPvdd at the moment it switches, a voltage difference appears in the terminals of the inductors, which causes a modification of the supply voltage applied to the terminals of the cells.

FIG. 4a shows a line macromodel 25 which, coupled with the rest of the system, models the injection of noise at the level of the line L1. This line L1 connects an output of the source cell C1 that transmits a data signal to inputs of the target cells C2 and C3, which receive the data signal transmitted by the cell C1.

More precisely, the cell C1 includes inputs I11-I1N and outputs O11-O1N′. The cell C2 includes inputs I21-I2M and outputs O21-O2M′. The cell C3 includes inputs I31-I3P and outputs O31-O3P′. What is modeled here is the line L1, which connects an output O11 of the cell C1 to inputs I21, I31 of the cells C2 and C3.

The line macromodel 25 includes passive elements such as resistors 29, 30, self 31, 32 and mutual 41, 42 inductors which depend on other, adjacent lines, and a capacitor 33. The resistors 29, 30 and the inductors 31, 32 are electrically connected in series. Moreover, the first terminal of the capacitor 33 is connected to a connection between the inductors, and the second terminal of the capacitor 33 is connected to the ground. This model 25 models the inductive and capacitive coupling of the line L1 with other lines and with the substrate of the circuit 1, the arrows 41 and 42 representing the mutual inductances between lines.

The values of the passive elements 29-33 are calculated from the length of the line L1, from the metal type of this line L1, and from the interconnections of the cells with each other. Known algorithms used in layout extraction software like CALIBRE or starRCXT make it possible to extract the values of the passive elements 29-33 for each line of the circuit 1 from the layout of the circuit 1.

Furthermore, in the line noise macromodel 25, the input capacitances of the target cells C2 and C3 are modeled by capacitors 36 and 37. The values of these input capacitances can be provided by a file included in the CORELIB. This CORELIB includes models and characteristics of the cells which can be used by design and verification software, as well as data extracted from measurements and simulations.

In a variant, the value of these input capacitances is extracted by means of a SPICE simulation which reproduces the measurement of the input impedances of the cell. More precisely, the cell C2 modeled at the transistor level is placed in a test environment represented in FIG. 4b. A small signal current source 45 which delivers a sinusoidal current is applied to an input of C2. And for various frequencies, the voltage observed in the input capacitance is measured.

For a purely capacitive input impedance, we have U=(1/j*C*pi*f)*i, U being the voltage measured in the input of the cell, C being the capacitance of the capacitor 36, f being the frequency of the current signal applied to the input of the cell, and i being the intensity of that current. It is thus possible to generate a Bode diagram from which the value of C is extracted by identification. This value depends on the evolution of the voltage U as a function of the frequency of the input signal. The extraction of the input impedances of the cell is done for each input of the cell.

In addition, in the line noise macromodel 25, a variation of the output signal O11(t) of C1 is modeled by a voltage source 47. As illustrated in FIG. 4c, this voltage source produces a periodic PWL (Piecewise Linear) signal 48 of period T. The signal 48 has a rising time RT, a falling time FT and a cyclic ratio (the ratio between the duration of the high state th and the period T) that are adjustable. This signal 48 thus models a switching of the output O11.

Since the injection of the line noise is calculated in the frequency domain, the Fourier transform of the signal 48 is calculated using known algorithms. A real part 49 and an imaginary part 50 of the frequency spectrum of the signal 48 are obtained.

Moreover, since the cells are not considered to switch at the same time, it is possible to use a distribution of the switching instants to find the moment at which the cells C1-CN switch and inject their noise into the circuit 1. In other words, it is possible to model the switching activity by determining average or marginal call times for a given configuration of each cell relative to a clock reference of the system. Thus, for each line macromodel, we calculate the spectrum of the noise source 47 resulting from the PWL signal, to which we apply an activity delay corresponding to the moment at which the noise is observable in the line.

In a variant, it is possible to consider all of the cells to switch at the same time. In that case, all of the lines L1-LN inject, at the same time, the noise signals they are likely to transport.

In one embodiment, the source 47 is considered not to be perfect, in order to model particular injection phenomena of the line L1. To this end, an output resistance 51 of the cell C1 is modeled. This resistance 51 is extracted using known techniques for extracting cell output impedance.

FIG. 5 shows an assembly of various noise injection macromodels with propagation models representing the substrate and the power networks. This assembly makes it possible to define a noise mapping of the circuit 1.

More precisely, each cell C1-CN is modeled by a noise injection model 8.1-8.N connected to the power network 5-7 and to an impedance network 55 modeling the substrate 4. The power network 5-7 is connected to the network 55. The injections of noise at the level of the lines L1-LN are modeled by the models 25.1-25.N connected to the network 55.

The models 8.1-8.N include passive elements and active elements for modeling a switching noise injected into the model of the system comprising the model 55 of the substrate.

Meanwhile, the line models 25.1-25.N include active and passive elements for modeling, in particular, the noise resulting from the coupling of the lines of the system with one another and with the model 55 of the substrate.

In addition, for the digital blocks of the circuit 1, an equivalent noise injection macromodel is defined, which models the injection of current noise during inrush currents at the cell level. To this end, a modeling of the switching activity is chosen which defines the moment at which the cells inject their noise into the model of the system. And the noise injection models are combined with one another using conventional Norton and Thevenin theorems so as to obtain equivalent noise injection macromodels 57.

Moreover, choice criteria are defined which make it possible to limit the number of lines to be considered for the calculation of the overall noise in the circuit 1. Thus, for example, it is possible to model, in particular, the injection of noise at the level of the lines that transport a certain type of signal, such as a clock signal. What is modeled in that case is a clock tree, which transports the signals that provide the synchronization of the various digital blocks of the circuit 1.

In another example, a choice is made to model the injection of noise at the level of the lines L1-LN that transport the signals most likely to switch. To determine these lines, a switching probability criterion for the cells C1-CN is defined, which depends on the functionality of the circuit 1. Lines L1-LN connected to the digital cells C1-CN having a switching probability greater than a threshold between 0 and 1 are then selected, and these lines are modeled. In general, the lines selected are those connected to the digital cells C1-CN that have the greatest switching probability, i.e. a probability greater than 0.7.

In order to define the switching probability, a behavioral simulator running a VDHL, VERILOG or VITAL model is used, and possible combinations (from a sample of combinations) of the signals applied to primary inputs of the circuit 1—i.e. to the inputs to which a signal outside the circuit can be applied—are exhaustively or pseudo-exhaustively tested. Based on the test patterns of the input signals, the probability of a cell's having an output signal that switches is determined.

In a variant, in order to determine the lines L1-LN that transport the signals most likely to switch, a graph of switching probabilities of the cells, constructed from a statistical behavior model of the cells of the system, is solved, and the switching probabilities are determined as a function of the solution of this graph.

In another example, a choice is made to model the injection of noise at the level of the lines L1-LN that are the longest ones in the circuit, and therefore the most likely to inject noise into the circuit. In one embodiment, the lines modeled are those whose length is greater than a threshold, this threshold being an arbitrary value between the minimum length and the maximum length of the lines. This threshold can also be defined relative to the average length of the lines of the system.

In another example, a choice is made to model the injection of noise at the level of the lines L1-LN closest to the analog blocks 3 of the circuit, these lines theoretically being the most likely to disturb these analog blocks.

The criteria chosen for modeling the injection of noise at the line level can be used alone or in combination.

Moreover, in one embodiment, equivalent noise injection macromodels are calculated for the lines parallel to each other that form a data bus. Thus, one injection model per data bus is preferably defined. In practice, in order to calculate this equivalent line model, the line elements are combined by calculating a sum of the resistances, a sum of the inductances and a paralleling of the capacitances of the macromodels of the lines parallel to each other.

It is understood that the various steps of the method according to the invention can be implemented by an electronic circuit or by means of a software program run by a computer, the software being stored on a medium such as a diskette, CD, DVD, USB drive or any other equivalent medium. The invention extends to the circuit manufacturing method comprising a preliminary noise modeling step according to the invention, and to the software for implementing the invention.

1-14. (canceled)

15. A computer readable medium comprising a computer executable instructions for modeling noise injected into a mixed digital and analog and/or RF system (“a mixed electronic system”) for designing said mixed electronic system comprising analog and digital cells, each cell being produced on a substrate of an integrated circuit and performing a particular function, said analog and digital cells being connected to each other by lines, each line connecting an output of a source cell to an input of a target cell and transporting a signal from said source cell to said target cell, said computer executable instructions being for:
modeling an injection of noise into said digital cells of said mixed electronic system using cell macro-models comprising passive elements and active elements for modeling a switching noise injected into a mixed electronic system model and a substrate model, wherein the switching noise is linked to a switching of said digital cells; and
modeling an injection of noise into said lines of said mixed electronic system using line macro-models comprising active and passive elements, which models noise resulting from a change in state of signals being transported through said lines, noise resulting from a coupling of said lines with one another and with said substrate model, thereby providing a noise model of the noise injected into said mixed electronic system.

16. The computer readable medium of claim 15, wherein each line macro-model comprises resistors, self and mutual inductors and a capacitor for modeling an impedance of an associated line of said mixed electronic system; and wherein values of said resistors, said self inductors and said capacitor depend on a length and metal type of said particular line, and mutual inductance values of said mutual inductors depend on lines adjacent to said associated line.

17. The computer readable medium of claim 16, wherein said each line macro-model comprises a voltage source; and further comprising computer executable instructions for modeling periodic changes in a state of an output signal from said source cell whose output is connected to said associated line that is being modeled by said each line macro-model using said voltage source.

18. The computer readable of claim 17, further comprising computer executable instruction for modeling a variation of said output signal from said source cell using said voltage source producing a periodic Piecewise Linear (PWL) signal having rising times (RT), falling times (FT) and a cyclic ratio that are adjustable.

19. The computer readable medium of claim 16, wherein said each line macro-model comprises a capacitor; and further comprising computer executable instructions for modeling an input impedance of said target cell whose input is connected to said associated line that is being modeled by said each line macro-model using said capacitor.

20. The computer readable medium of claim 19, further comprising computer executable instructions for extracting, by said each line macro-model, a capacitance value of said capacitor modeling the input impedance of said target cell by:
applying a sinusoidal signal to an input of said target cell;
measuring observable voltages in the input of said target cell for a plurality of frequencies of said sinusoidal signal; and
calculating a capacitance of said capacitor from variation of said observable voltages as a function of said plurality of frequencies of said sinusoidal signal, thereby extracting a capacitance value of said capacitor modeling the input impedance of said target cell.

21. The computer readable medium of claim 15, further comprising computer executable instructions for selecting and modeling lines transporting a clock signal.

22. The computer readable medium of claim 15, further comprising computer executable instructions for selecting and modeling lines whose length is greater than a threshold, said threshold being between a shortest line length and a longest line length.

23. The computer readable medium of claim 15, further comprising computer executable instructions for selecting and modeling said lines connected to said digital cells having a switching probability greater than a threshold, said threshold being between 0 and 1.

24. The computer readable medium of claim 23, further comprising computer executable instructions for:
performing, in a simulation environment, an exhaustive or pseudo-exhaustive test of possible combinations of signals applied from outside said mixed electronic system applied to primary inputs of said digital cells; and
determining said switching probabilities as a function of said exhaustive or pseudo-exhaustive test of possible combinations.

25. The computer readable medium claim 23, further comprising computer executable instructions for:
solving a graph of switching probabilities of said cells, constructed from a statistical behavior model of said cells of said mixed electronic system; and
determining said switching probabilities as a function of a solution of said graph, thereby determining said switching probabilities of said cells of said mixed electronic system.

26. The computer readable medium of claim 15, further comprising computer executable instructions for modeling the injection of noise into lines closest to said analog cells.

27. The computer readable medium of claim 15, further comprising computer executable instructions for combining said line macro-models of lines that are parallel to each other and part of a data bus, thereby obtaining an equivalent macro-model for modeling injection of noise into said data bus.

28. The method of manufacturing an integrated circuit of said mixed electronic system using said noise model of said mixed electronic system of claim 15.

29. Apparatus for modeling noise injected into a mixed digital and analog and/or RF system (“a mixed electronic system”) for designing said mixed electronic system comprising analog and digital cells connected to each other by lines, each cell of said mixed electronic system being produced on a substrate of an integrated circuit and performing a particular function, each line connecting an output of a source cell to an input of a target cell and transporting a signal from said source cell to said target cell, said apparatus comprising:
cell macro-models comprising passive elements and active elements for modeling a switching noise injected into a mixed electronic system model and a substrate model, the switching noise being linked to a switching of said digital cells, thereby modeling an injection of noise into said digital cells of said mixed electronic system; and
line macro-models comprising active and passive elements for modeling noise resulting from a change in state of signals being transported through said lines, noise resulting from a coupling of said lines with one another and with said substrate model, thereby modeling an injection of noise into said lines of said mixed electronic system; and
wherein said cell macro-models and said line macro-models of said apparatus provide a noise model of the noise injected into said mixed electronic system.

30. The apparatus of claim 29, wherein each line macro-model comprises resistors, self and mutual inductors and a capacitor for modeling an impedance of an associated line of said mixed electronic system, wherein values of said resistors, said self inductors and said capacitor depend on a length and metal type of said particular line, and mutual inductance values of said mutual inductors depend on said lines adjacent to said associated line.

31. The apparatus of claim 30, wherein said each line macro-model comprises a voltage source for modeling periodic changes in a state of an output signal from said source cell whose output is connected to said associated line that is being modeled by said each line macro-model.

32. The apparatus of claim 31, wherein said voltage source is operable to produce a periodic Piecewise Linear (PWL) signal having rising times (RT), falling times (FT) and a cyclic ratio that are adjustable, thereby modeling a variation of said output signal from said source cell.

33. The apparatus of claim 30, wherein said each line macro-model comprises a capacitor for modeling an input impedance of said target cell whose input is connected to said associated line that is being modeled by said each line macro-model.

34. The apparatus of claim 33, wherein said each line macro-model is operable to extract capacitance value of said capacitor modeling the input impedance of said target cell by:
applying a sinusoidal signal to an input of said target cell;
measuring observable voltages in the input of said target cell for a plurality of frequencies of said sinusoidal signal; and
calculating a capacitance of said capacitor from variation of said observable voltages as a function of said plurality of frequencies of said sinusoidal signal.

35. The apparatus of claim 29, further comprising a device for selecting lines transporting a clock signal; and wherein said line macro-models are operable to model said lines transporting a clock signal.

36. The apparatus of claim 29, further comprising a device for selecting lines whose length is greater than a threshold, said threshold being between a shortest line length and a longest line length; and wherein said line macro-models are operable to model said lines whose length is greater than said threshold.

37. The apparatus of claim 29, further comprising a device for selecting lines connected to said digital cells having a switching probability greater than a threshold, said threshold being between 0 and 1; and wherein said line macro-models are operable to model said lines connected to said digital cells having said switching probability greater than said threshold.

38. The apparatus of claim 37, wherein said line macro-models are operable to:
perform, in a simulation environment, an exhaustive or pseudo-exhaustive test of possible combinations of signals applied from outside said mixed electronic system applied to primary inputs of said digital cells; and
determine said switching probabilities as a function of said exhaustive or pseudo-exhaustive test of possible combinations.

39. The apparatus of claim 37, wherein said line macro-models are operable to:
solving a graph of switching probabilities of said cells, constructed from a statistical behavior model of said cells of said mixed electronic system; and
determining said switching probabilities as a function of a solution of said graph, thereby determining said switching probabilities of said cells of said mixed electronic system.

40. The apparatus of claim 29, wherein said line macro-models are operable to model the injection of noise into lines closest to said analog cells.

41. The apparatus of claim 29, further comprising an equivalent macro-model for modeling an injection of noise into a data bus formed by parallel lines, said equivalent macro-model formed by combining said line macro-models of lines in said data bus.
